(19) United States
(12) Patent Application Publication
(10) Pub. No.: US 2022/0088680 A1
(43) Pub. Date: Mar. 24, 2022

(54) ADDITIVE MANUFACTURING SYSTEM AND METHODS FOR REPAIRING COMPONENTS

(71) Applicant: General Electric Company, Schenectady, NY (US)

(72) Inventors: Richard Roy Worthing, Jr., Liberty Township, OH (US); John Louis Cupito, Loveland, OH (US); Anthony John Matacia, Loveland, OH (US); Hongyuan Shen, Singapore (SG); Hongqing Sun, Rexford, NY (US); Joseph Edward Hampshire, West Chester, OH (US); Jinjie Shi, Mason, OH (US); Glen Charles Fedyk, Fairfield Township, OH (US); Thines Kumar Maragatham Perumal, Pasir Ris (SG); Meddah Hadjar, Liberty Township, OH (US)

(21) Appl. No.: 17/419,493

(22) PCT Filed: Jan. 30, 2019
(86) PCT No.: PCT/SG2019/050049

§ 371 Date: Jun. 29, 2021

(51) Int. Cl. B22F 10/28; B33Y 10/00; B33Y 30/00; B33Y 40/20; B22F 10/66; B33Y 80/00; B22F 12/90; B23K 26/342; B23K 26/03; B23P 6/00; F01D 5/14

(52) U.S. Cl. CPC B22F 10/28; B33Y 10/00; B33Y 30/00; B33Y 40/20; B22F 10/66; B23K 2101/001; B22F 12/90; B23K 26/342; B23K 26/032; B23P 6/007; F01D 5/14; B33Y 80/00

(57) ABSTRACT

A system (50) and method (200) for repairing one or more components (70) using an additive manufacturing process includes securing the components (70) in a tooling assembly (52) such that a repair surface (72) of each component (70) is positioned within a single build plane (82), determining a repair toolpath (76) corresponding to the repair surface (72) of each component using a vision system (56), depositing a layer of additive powder (72) over the repair surface (72) of each component (70) using a powder dispensing assembly (112), and selectively irradiating the layer of additive powder (72) along the repair toolpath (76) to fuse the layer of additive powder (72) onto the repair surface (72) of each component (70).

### FIELD

The present disclosure generally relates to repairing or rebuilding components using an additive manufacturing process, and more particularly to additive manufacturing systems and methods of performing such repair or rebuild procedures.

### BACKGROUND

Machine or device components frequently experience damage, wear, and/or degradation throughout their service life. For example, serviced compressor blades of a gas turbine engine show erosion, defects, and/or cracks after long term use. Specifically, for example, such blades are subject to significant stresses which inevitably cause blades to wear over time, particularly near the tip of the blade. For example, blade tips are susceptible to wear or damage from friction or rubbing between the blade tips and shrouds, from chemical degradation or oxidation from hot gasses, from fatigue caused by cyclic loading and unloading, from diffusion creep of crystalline lattices, etc.

Notably, worn or damaged blades may result in machine failure or performance degradation if not corrected. Specifically, such blades may cause a turbomachine to exhibit reduced operating efficiency as gaps between blade tips and turbine shrouds may allow gasses to leak through the turbine stages without being converted to mechanical energy. When efficiency drops below specified levels, the turbomachine is typically removed from service for overhaul and refurbishment. Moreover, weakened blades may result in complete fractures and catastrophic failure of the engine.

As a result, compressor blades for a gas turbine engine are typically the target of frequent inspections, repairs, or replacements. It is frequently very expensive to replace such blades altogether, however, some can be repaired for extended lifetime at relatively low cost (as compared to replacement with entirely new blades). Nevertheless, existing repair processes tend to be labor intensive and time consuming.

For example, a traditional compressor blade tip repair process uses a welding/cladding technique where repair materials are supplied, in either powder or wire form, to the blade tips. The repair materials are melted by focused power source (e.g., laser, e-beam, plasma arc, etc.) and bonded to blade tips. However, blades repaired with such welding/cladding technique need tedious post-processing to achieve the target geometry and surface finish. Specifically, due to the bulky feature size of the welding/cladding repair joint, the repaired blades require heavy machining to remove the extra materials on the tip, and further require a secondary polishing process to achieve a target surface finish. Notably, such a process is performed on a single blade at a time, is very labor intensive and tedious, and results in very large overall labor costs for a single repair.

Alternatively, other direct-energy-deposition (DED) methods may be used for blade repair, e.g., such as cold spray, which directs high-speed metal powders to bombard the target or base component such that the powders deform and deposit on the base component. However, none of these DED methods are suitable for batch processing or for repairing a large number of components in a time efficient manner, thus providing little or no business value.

Accordingly, a system and method for repairing or rebuilding serviced components would be useful. More particularly, an additive manufacturing machine and process for quickly and effectively rebuilding or repairing worn compressor blades would be particularly beneficial.

### BRIEF DESCRIPTION

Aspects and advantages will be set forth in part in the following description, or may be obvious from the description, or may be learned through practice of the invention.

According to one embodiment of the present subject matter, a method for repairing one or more components using an additive repair system is provided. The method includes securing the one or more components in a tooling assembly, each of the one or more components having a repair surface. The method further includes determining a repair toolpath corresponding to the repair surface of each of the one or more components using a vision system, depositing a layer of additive powder over the repair surface of each of the one or more components using a powder dispensing assembly, and selectively irradiating the layer of additive powder along the repair toolpath to fuse the layer of additive powder onto the repair surface of each of the one or more components.

According to another exemplary embodiment, an additive repair system for repairing one or more components is provided. The additive repair system includes a tooling assembly for securing the one or more components, each of the one or more components having a repair surface. A vision system determines a repair toolpath associated with each of the one or more components within the build plane, a powder dispensing assembly deposits a layer of additive powder over the repair surface of each of the one or more components, and an energy source selectively irradiates the layer of additive powder along the repair toolpath to fuse the layer of additive powder onto the repair surface of each of the one or more components.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 shows a schematic representation of an additive repair system that may be used for repairing or rebuilding components according to an exemplary embodiment of the present subject matter.

FIG. 2 depicts certain components of a controller according to example embodiments of the present subject matter.

FIG. 3 shows a schematic view of an additive manufacturing machine that may be used as part of the exemplary additive manufacturing system of FIG. 1 according to an exemplary embodiment of the present subject matter.

FIG. 4 shows a close-up schematic view of a build platform of the exemplary additive manufacturing machine of FIG. 3 according to an exemplary embodiment of the present subject matter.

FIG. 5 is a method for repairing one or more components using an additive manufacturing machine in accordance with one embodiment of the present disclosure.

FIG. 6 shows a blade which may be repaired or rebuilt using the exemplary additive repair system of FIG. 1 or the exemplary method of FIG. 5 according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. In addition, the terms “upstream” and “downstream” refer to the relative direction with respect to the motion of an object or a flow of fluid. For example, “upstream” refers to the direction from which the object has moved or fluid has flowed, and “downstream” refers to the direction to which the object is moving or the fluid is flowing. Furthermore, as used herein, terms of approximation, such as “approximately,” “substantially,” or “about,” refer to being within a ten percent margin of error.

Aspects of the present subject matter are directed to a system and method for repairing one or more components using an additive manufacturing process. The method includes securing the components in a tooling assembly such that a repair surface of each component is positioned within a single build plane, determining a repair toolpath corresponding to the repair surface of each component using a vision system, depositing a layer of additive powder over the repair surface of each component using a powder dispensing assembly, and selectively irradiating the layer of additive powder along the repair toolpath to fuse the layer of additive powder onto the repair surface of each component.

As described in detail below, exemplary embodiments of the present subject matter involve the use of additive manufacturing machines or methods. As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components.

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

In addition to using a direct metal laser sintering (DMLS) or direct metal laser melting (DMLM) process where an energy source is used to selectively sinter or melt portions of a layer of powder, it should be appreciated that according to alternative embodiments, the additive manufacturing process may be a “binder jetting” process. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. The liquid binding agent may be, for example, a photo-curable polymer or another liquid bonding agent. Other suitable additive manufacturing methods and variants are intended to be within the scope of the present subject matter.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example a three-dimensional computer model, of the component. Accordingly, a three-dimensional design model of the component may be defined prior to manufacturing. In this regard, a model or prototype of the component may be scanned to determine the three-dimensional information of the component. As another example, a model of the component may be constructed using a suitable computer aided design (CAD) program to define the three-dimensional design model of the component.

The design model may include 3D numeric coordinates of the entire configuration of the component including both external and internal surfaces of the component. For example, the design model may define the body, the surface, and/or internal passageways such as openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The plurality of successive cross-sectional slices together form the 3D component. The component is then “built-up” slice-by-slice, or layer-by-layer, until finished.

In this manner, the components described herein may be fabricated using the additive process, or more specifically each layer is successively formed, e.g., by fusing or polymerizing a plastic using laser energy or heat or by sintering or melting metal powder. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

Each successive layer may be, for example, between about 10 μm and 200 μm, although the thickness may be selected based on any number of parameters and may be any suitable size according to alternative embodiments. Therefore, utilizing the additive formation methods described above, the components described herein may have cross sections as thin as one thickness of an associated powder layer, e.g., 10 μm, utilized during the additive formation process.

In addition, utilizing an additive process, the surface finish and features of the components may vary as need depending on the application. For example, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer which corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

After fabrication of the component is complete, various post-processing procedures may be applied to the component. For example, post processing procedures may include removal of excess powder by, for example, blowing or vacuuming. Other post processing procedures may include a stress relief process. Additionally, thermal, mechanical, and/or chemical post processing procedures can be used to finish the part to achieve a desired strength, surface finish, and other component properties or features.

Notably, in exemplary embodiments, several aspects and features of the present subject matter were previously not possible due to manufacturing restraints. However, the present inventors have advantageously utilized current advances in additive manufacturing techniques to improve various components and the method of additively manufacturing such components. While the present disclosure is not limited to the use of additive manufacturing to form these components generally, additive manufacturing does provide a variety of manufacturing advantages, including ease of manufacturing, reduced cost, greater accuracy, etc.

Also, the additive manufacturing methods described above enable much more complex and intricate shapes and contours of the components described herein to be formed with a very high level of precision. For example, such components may include thin additively manufactured layers, cross sectional features, and component contours. In addition, the additive manufacturing process enables the manufacture of a single component having different materials such that different portions of the component may exhibit different performance characteristics. The successive, additive nature of the manufacturing process enables the construction of these novel features. As a result, components formed using the methods described herein may exhibit improved performance and reliability.

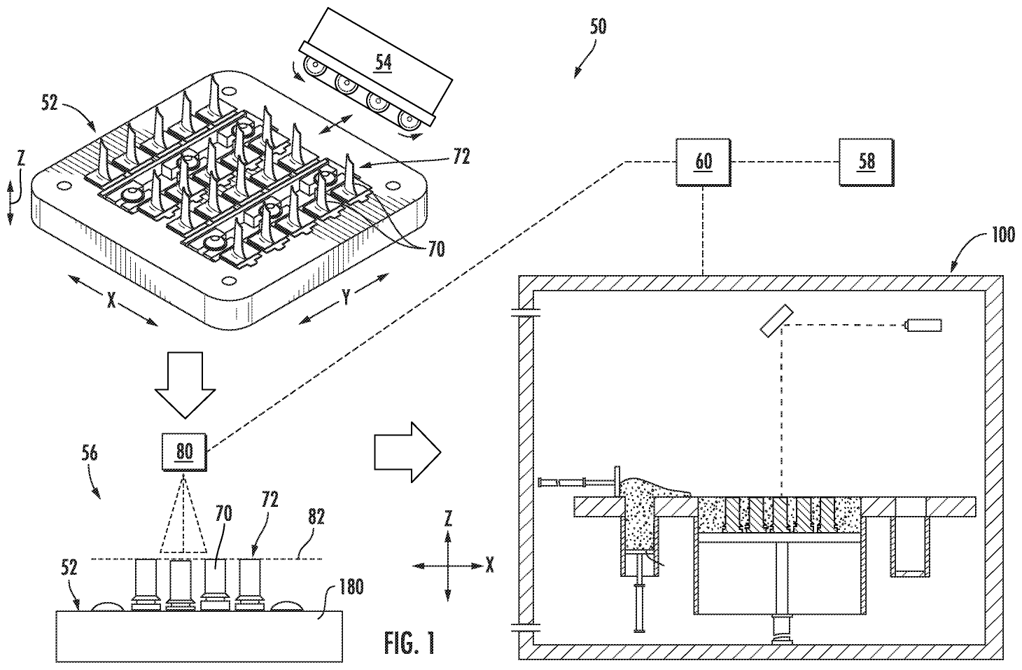

Referring now to FIG. 1, an exemplary additive repair system 50 will be described according to an exemplary embodiment of the present subject matter. As illustrated, additive repair system 50 generally includes a tooling fixture or assembly 52, a material removal assembly 54, a vision system 56, a user interface panel 58, and an additive manufacturing machine or system 100. Furthermore, a system controller 60 may be operably coupled with some or all parts of additive repair system 50 for facilitating system operation. For example, system controller 60 may be operably coupled to user interface panel 58 to permit operator communication with additive repair system 50, e.g., to input commands, upload printing toolpaths or CAD models, initiating operating cycles, etc. Controller 60 may further be in communication with vision system 56 for receiving imaging data and with AM machine 100 for performing a printing process.

According to exemplary embodiments, tooling assembly 52 is generally configured for supporting a plurality of components in a desired position and orientation. According to exemplary embodiments, tooling assembly 52 supports 20 high pressure compressor blades 70 during an additive manufacturing repair process. Specifically, the additive manufacturing process may be a powder bed fusion process (e.g., a DMLM or DMLS process as described above). Although the repaired components are illustrated herein as compressor blades 70 of a gas turbine engine, it should be appreciated that any other suitable component may be repaired, such as turbine blades, other airfoils, or components from other machines. In order to achieve proper recoating and to facilitate the printing process, it may be desirable to position all blades 70 in the same orientation and at the same height such that a repair surface 72 of each blade is in a single build plane. Tooling assembly 52 is a fixture intended to secure blades 70 in such desired position and orientation.

Material removal assembly 54 may include a machine or device configured for grinding, machining, brushing, etching, polishing, wire electrical discharge machining (EDM), cutting, or otherwise substantively modifying a component, e.g., by subtractive modification or material removal. For example, material removal assembly 54 may include a belt grinder, a disc grinder, or any other grinding or abrasive mechanism. According to an exemplary embodiment, material removal assembly 54 may be configured for removing material from a tip of each blade 70 to obtain a desirable repair surface 72. For example, as explained briefly above, material removal assembly 54 may remove at least a portion of blades 70 that have been worn or damaged, e.g., which may include microcracks, pits, abrasions, defects, foreign material, depositions, imperfections, and the like. According to an exemplary embodiment, each blade 70 is prepared using material removal assembly 54 to achieve the desired repair surface 72, after which the blades 70 are all mounted in tooling assembly 52 and leveled appropriately. However, according to alternative embodiments, material removal assembly 54 may grind each blade 70 as it is fixed in position in tooling assembly 52.

After the blades are prepared, vision system 56 may be used to obtain an image or digital representation of the precise position and coordinates of each blade 70 positioned in tooling assembly 52. In this regard, according to exemplary embodiments, vision system 56 may include any suitable camera or cameras 80, scanners, imaging devices, or other machine vision device that may be operably configured to obtain image data that includes a digital representation of one or more fields of view. Such a digital representation may sometimes be referred to as a digital image or an image; however, it will be appreciated that the present disclosure may be practiced without rendering such a digital representation in human-visible form. Nevertheless, in some embodiments, a human-visible image corresponding to a field of view may be displayed on the user interface 58 based at least in part on such a digital representation of one or more fields of view.

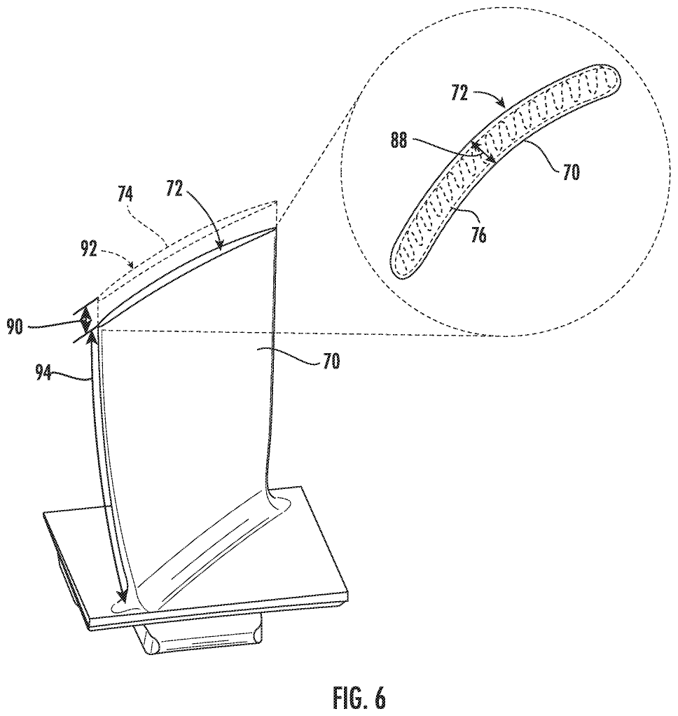

Vision system 56 allows the additive repair system 50 to obtain information pertaining to one or more blades 70 onto which one or more repair segments 74 (see FIG. 6) may be respectively additively printed. In particular, the vision system 56 allows the one or more blades 70 to be located and defined so that the additive manufacturing machine 100 may be instructed to print one or more repair segments 74 on a corresponding one or more blades 70 with suitably high accuracy and precision. According to an exemplary embodiment, the one or more blades 70 may be secured to tooling assembly 52, a mounting plate, a build platform, or any other fixture with repair surface 72 of the respective blades 70 aligned to a single build plane 82.

The one or more cameras 80 of the vision system 56 may be configured to obtain two-dimensional or three-dimensional image data, including a two-dimensional digital representation of a field of view and/or a three-dimensional digital representation of a field of view. Alignment of the repair surface 72 of the blades 70 with the build plane 82 allows the one or more cameras 80 to obtain higher quality images. For example, the one or more cameras 80 may have a focal length adjusted or adjustable to the build plane 82. With the repair surface 72 of one or more blades 70 aligned to the build plane 82, the one or more cameras may readily obtain digital images of the repair surface 72. The one or more cameras 80 may include a field of view that encompasses all or a portion of the one or more blades 70 secured to the tooling assembly 52. For example, a single field of view may be wide enough to encompass a plurality of blades 70, such as each of a plurality of workpieces secured to tooling assembly 52. Alternatively, a field of view may more narrowly focus on an individual blade 70 such that digital representations of respective blades 70 are obtained separately. It will be appreciated that separately obtained digital images may be stitched together to obtain a digital representation of a plurality of components or blades 70. In some embodiments, the camera 80 may include a collimated lens configured to provide a flat focal plane, such that blades 70 or portions thereof located towards the periphery of the field of view are not distorted. Additionally, or in the alternative, the vision system 56 may utilize a distortion correction algorithm to address any such distortion.

Image data obtained by the vision system 56, including a digital representation of one or more blades 70 may be transmitted to a control system, such as controller 60. Controller 60 may be configured to determine a repair surface 72 of each of a plurality of blades 70 from one or more digital representations of one or more fields of view having been captured by the vision system 56, and then determine one or more coordinates of the repair surface 72 of respective ones of the plurality of blades 70. Based on the one or more digital representations, controller 60 may generate one or more print commands (e.g., corresponding to one or more repair toolpaths 76, see FIG. 6), which may be transmitted to an additive manufacturing machine 100 such that the additive manufacturing machine 100 may additively print a plurality of repair segments 74 on respective ones of the plurality of blades 70. The one or more print commands may be configured to additively print a plurality of repair segments 74 with each respective one of the plurality of repair segments 74 being located on the repair surface 72 of a corresponding blade 70.

Each of the components and subsystems of additive repair system 50 are described herein in the context of an additive blade repair process. However, it should be appreciated that aspects of the present subject matter may be used to repair or rebuild any suitable components. The present subject matter is not intended to be limited to the specific repair process described. In addition, FIG. 1 illustrates each of the systems as being distinct or separate from each other and implies the process steps should be performed in a particular order, however, it should be appreciated that these subsystems may be integrated into a single machine, process steps may be swapped, and other changes to the build process may be implemented while remaining within the scope of the present subject matter.

For example, vision system 56 and additive manufacturing machine 100 may be provided as a single, integrated unit or as separate stand-alone units. In addition, controller 60 may include one or more control systems. For example, a single controller 60 may be operably configured to control operations of the vision system 56 and the additive manufacturing machine 100, or separate controllers 60 may be operably configured to respectively control the vision system 56 and the additive manufacturing machine 100.

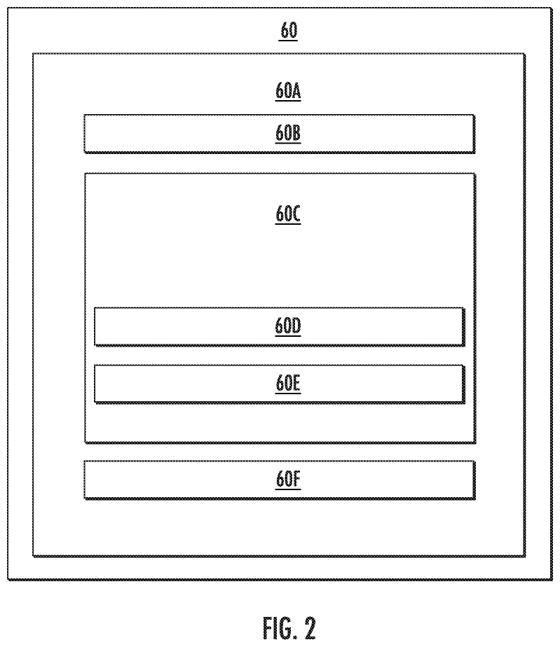

Operation of additive repair system 50, vision system 56, and AM machine 100 may be controlled by electromechanical switches or by a processing device or controller 60 (see, e.g., FIGS. 1 through 2). According to exemplary embodiments, controller 60 may be operatively coupled to user interface panel 58 for user manipulation, e.g., to control the operation of various components of AM machine 100 or system 50. In this regard, controller 60 may operably couple all systems and subsystems within additive repair system 50 to permit communication and data transfer therebetween. In this manner, controller 60 may be generally configured for operating additive repair system 50 or performing one or more of the methods described herein.

FIG. 2 depicts certain components of controller 60 according to example embodiments of the present disclosure. Controller 60 can include one or more computing device(s) 60A which may be used to implement methods as described herein. Computing device(s) 60A can include one or more processor(s) 60B and one or more memory device(s) 60C. The one or more processor(s) 60B can include any suitable processing device, such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs) (e.g., dedicated to efficiently rendering images), processing units performing other specialized calculations, etc. The memory device(s) 60C can include one or more non-transitory computer-readable storage medium(s), such as RAM, ROM, EEPROM, EPROM, flash memory devices, magnetic disks, etc., and/or combinations thereof.

The memory device(s) 60C can include one or more computer-readable media and can store information accessible by the one or more processor(s) 60B, including instructions 60D that can be executed by the one or more processor(s) 60B. For instance, the memory device(s) 60C can store instructions 60D for running one or more software applications, displaying a user interface, receiving user input, processing user input, etc. In some implementations, the instructions 60D can be executed by the one or more processor(s) 60B to cause the one or more processor(s) 60B to perform operations, e.g., such as one or more portions of methods described herein. The instructions 60D can be software written in any suitable programming language or can be implemented in hardware. Additionally, and/or alternatively, the instructions 60D can be executed in logically and/or virtually separate threads on processor(s) 60B.

The one or more memory device(s) 60C can also store data 60E that can be retrieved, manipulated, created, or stored by the one or more processor(s) 60B. The data 60E can include, for instance, data to facilitate performance of methods described herein. The data 60E can be stored in one or more database(s). The one or more database(s) can be connected to controller 60 by a high bandwidth LAN or WAN, or can also be connected to controller through one or more network(s) (not shown). The one or more database(s) can be split up so that they are located in multiple locales. In some implementations, the data 60E can be received from another device.

The computing device(s) 60A can also include a communication module or interface 60F used to communicate with one or more other component(s) of controller 60 or additive manufacturing machine 100 over the network(s). The communication interface 60F can include any suitable components for interfacing with one or more network(s), including for example, transmitters, receivers, ports, controllers, antennas, or other suitable components.

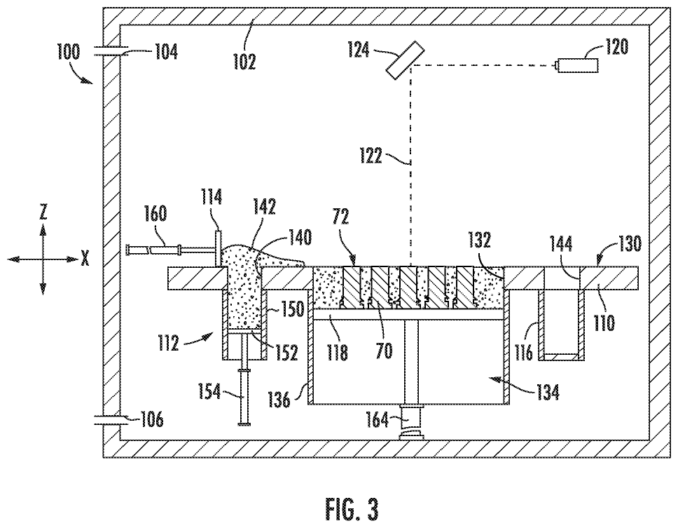

Referring now to FIG. 3, an exemplary laser powder bed fusion system, such as a DMLS or DMLM system 100, will be described according to an exemplary embodiment. Specifically, AM system 100 is described herein as being used to build or repair blades 70. It should be appreciated that blades 70 are only an exemplary component to be built or repaired and are used primarily to facilitate description of the operation of AM machine 100. The present subject matter is not intended to be limited in this regard, but instead AM machine 100 may be used for printing repair segments on any suitable plurality of components.

As illustrated, system 100 includes a fixed enclosure or build area 102 which provides a contaminant-free and controlled environment for performing an additive manufacturing process. In this regard, for example, enclosure 102 serves to isolate and protect the other components of the system 100. In addition, enclosure 102 may be provided with a flow of an appropriate shielding gas, such as nitrogen, argon, or another suitable gas or gas mixture. In this regard, enclosure 102 may define a gas inlet port 104 and a gas outlet port 106 for receiving a flow of gas to create a static pressurized volume or a dynamic flow of gas.

Enclosure 102 may generally contain some or all components of AM system 100. According to an exemplary embodiment, AM system 100 generally includes a table 110, a powder supply 112, a scraper or recoater mechanism 114, an overflow container or reservoir 116, and a build platform 118 positioned within enclosure 102. In addition, an energy source 120 generates an energy beam 122 and a beam steering apparatus 124 directs energy beam 122 to facilitate the AM process as described in more detail below. Each of these components will be described in more detail below.

According to the illustrated embodiment, table 110 is a rigid structure defining a planar build surface 130. In addition, planar build surface 130 defines a build opening 132 through which build chamber 134 may be accessed. More specifically, according to the illustrated embodiment, build chamber 134 is defined at least in part by vertical walls 136 and build platform 118. In addition, build surface 130 defines a supply opening 140 through which additive powder 142 may be supplied from powder supply 112 and a reservoir opening 144 through which excess additive powder 142 may pass into overflow reservoir 116. Collected additive powders may optionally be treated to sieve out loose, agglomerated particles before re-use.

Powder supply 112 generally includes an additive powder supply container 150 which generally contains a volume of additive powder 142 sufficient for some or all of the additive manufacturing process for a specific part or parts. In addition, powder supply 112 includes a supply platform 152, which is a plate-like structure that is movable along the vertical direction within powder supply container 150. More specifically, a supply actuator 154 vertically supports supply platform 152 and selectively moves it up and down during the additive manufacturing process.

AM system 100 further includes recoater mechanism 114, which is a rigid, laterally-elongated structure that lies proximate build surface 130. For example, recoater mechanism 114 may be a hard scraper, a soft squeegee, or a roller. Recoater mechanism 114 is operably coupled to a recoater actuator 160 which is operable to selectively move recoater mechanism 114 along build surface 130. In addition, a platform actuator 164 is operably coupled to build platform 118 and is generally operable for moving build platform 118 along the vertical direction during the build process. Although actuators 154, 160, and 164 are illustrated as being hydraulic actuators, it should be appreciated that any other type and configuration of actuators may be used according to alternative embodiments, such as pneumatic actuators, hydraulic actuators, ball screw linear electric actuators, or any other suitable vertical support means. Other configurations are possible and within the scope of the present subject matter.

As used herein, “energy source” may be used to refer to any device or system of devices configured for directing an energy beam of suitable power and other operating characteristics towards a layer of additive powder to sinter, melt, or otherwise fuse a portion of that layer of additive powder during the build process. For example, energy source 120 may be a laser or any other suitable irradiation emission directing device or irradiation device. In this regard, an irradiation or laser source may originate photons or laser beam irradiation which is directed by the irradiation emission directing device or beam steering apparatus.

According to an exemplary embodiment, beam steering apparatus 124 includes one or more mirrors, prisms, lenses, and/or electromagnets operably coupled with suitable actuators and arranged to direct and focus energy beam 122. In this regard, for example, beam steering apparatus 124 may be a galvanometer scanner that moves or scans the focal point of the laser beam 122 emitted by energy source 120 across the build surface 130 during the laser melting and sintering processes. In this regard, energy beam 122 can be focused to a desired spot size and steered to a desired position in plane coincident with build surface 130. The galvanometer scanner in powder bed fusion technologies is typically of a fixed position but the movable mirrors/lenses contained therein allow various properties of the laser beam to be controlled and adjusted. According to exemplary embodiments, beam steering apparatus may further include one or more of the following: optical lenses, deflectors, mirrors, beam splitters, telecentric lenses, etc.

It should be appreciated that other types of energy sources 120 may be used which may use an alternative beam steering apparatus 124. For example, an electron beam gun or other electron source may be used to originate a beam of electrons (e.g., an “e-beam”). The e-beam may be directed by any suitable irradiation emission directing device preferably in a vacuum. When the irradiation source is an electron source, the irradiation emission directing device may be, for example, an electronic control unit which may include, for example, deflector coils, focusing coils, or similar elements. According to still other embodiments, energy source 120 may include one or more of a laser, an electron beam, a plasma arc, an electric arc, etc.

Prior to an additive manufacturing process, recoater actuator 160 may be lowered to provide a supply of powder 142 of a desired composition (for example, metallic, ceramic, and/or organic powder) into supply container 150. In addition, platform actuator 164 may move build platform 118 to an initial high position, e.g., such that it substantially flush or coplanar with build surface 130. Build platform 118 is then lowered below build surface 130 by a selected layer increment. The layer increment affects the speed of the additive manufacturing process and the resolution of a components or parts (e.g., blades 70) being manufactured. As an example, the layer increment may be about 10 to 100 micrometers (0.0004 to 0.004 in.).

Additive powder is then deposited over the build platform 118 before being fused by energy source 120. Specifically, supply actuator 154 may raise supply platform 152 to push powder through supply opening 140, exposing it above build surface 130. Recoater mechanism 114 may then be moved across build surface 130 by recoater actuator 160 to spread the raised additive powder 142 horizontally over build platform 118 (e.g., at the selected layer increment or thickness). Any excess additive powder 142 drops through the reservoir opening 144 into the overflow reservoir 116 as recoater mechanism 114 passes from left to right (as shown in FIG. 3). Subsequently, recoater mechanism 114 may be moved back to a starting position.

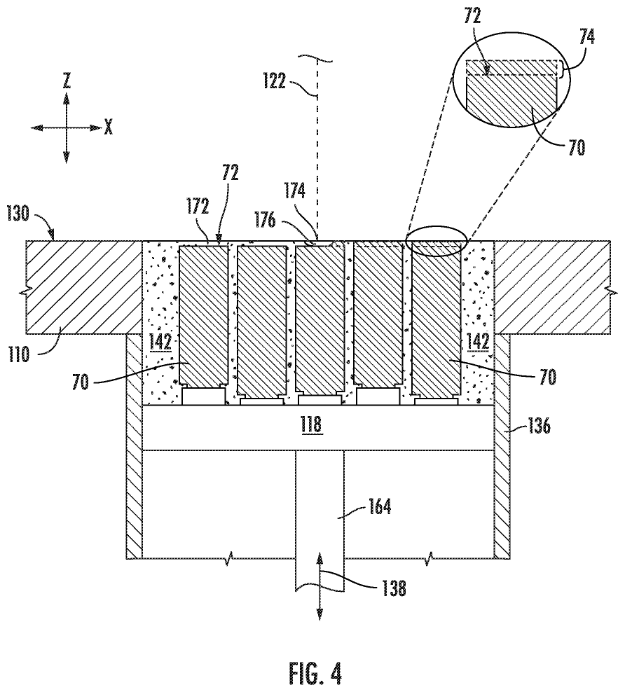

Therefore, as explained herein and illustrated in FIG. 3, recoater mechanism 114, recoater actuator 160, supply platform 152, and supply actuator 154 may generally operate to successively deposit layers of additive powder 142 or other additive material to facilitate the print process. As such, these components may collectively be referred to herein as powder dispensing apparatus, system, or assembly. The leveled additive powder 142 may be referred to as a “build layer” 172 (see FIG. 4) and the exposed upper surface thereof may be referred to as build surface 130. When build platform 118 is lowered into build chamber 134 during a build process, build chamber 134 and build platform 118 collectively surround and support a mass of additive powder 142 along with any components (e.g., blades 70) being built. This mass of powder is generally referred to as a “powder bed,” and this specific category of additive manufacturing process may be referred to as a “powder bed process.”

During the additive manufacturing process, the directed energy source 120 is used to melt a two-dimensional cross-section or layer of the component (e.g., blades 70) being built. More specifically, energy beam 122 is emitted from energy source 120 and beam steering apparatus 124 is used to steer the focal point 174 of energy beam 122 over the exposed powder surface in an appropriate pattern (referred to herein as a “toolpath”). A small portion of exposed layer of the additive powder 142 surrounding focal point 174, referred to herein as a “weld pool” or “melt pool” or “heat effected zone” 176 (best seen in FIG. 2) is heated by energy beam 122 to a temperature allowing it to sinter or melt, flow, and consolidate. As an example, melt pool 176 may be on the order of 100 micrometers (0.004 in.) wide. This step may be referred to as fusing additive powder 142.

Build platform 118 is moved vertically downward by the layer increment, and another layer of additive powder 142 is applied in a similar thickness. The directed energy source 120 again emits energy beam 122 and beam steering apparatus 124 is used to steer the focal point 174 of energy beam 122 over the exposed powder surface in an appropriate pattern. The exposed layer of additive powder 142 is heated by energy beam 122 to a temperature allowing it to sinter or melt, flow, and consolidate both within the top layer and with the lower, previously-solidified layer. This cycle of moving build platform 118, applying additive powder 142, and then directed energy beam 122 to melt additive powder 142 is repeated until the entire component (e.g., blades 70) is complete.

Now that the construction and configuration of additive repair system 50 has been described according to exemplary embodiments of the present subject matter, an exemplary method 200 for repairing or rebuilding a component using an additive repair system will be described according to an exemplary embodiment of the present subject matter. Method 200 can be used to repair blades 70 using additive repair system 50 and AM machine 100, or to repair any other suitable component using any other suitable additive manufacturing machine or system. In this regard, for example, controller 60 may be configured for implementing some or all steps of method 200. Further, it should be appreciated that the exemplary method 200 is discussed herein only to describe exemplary aspects of the present subject matter, and is not intended to be limiting.

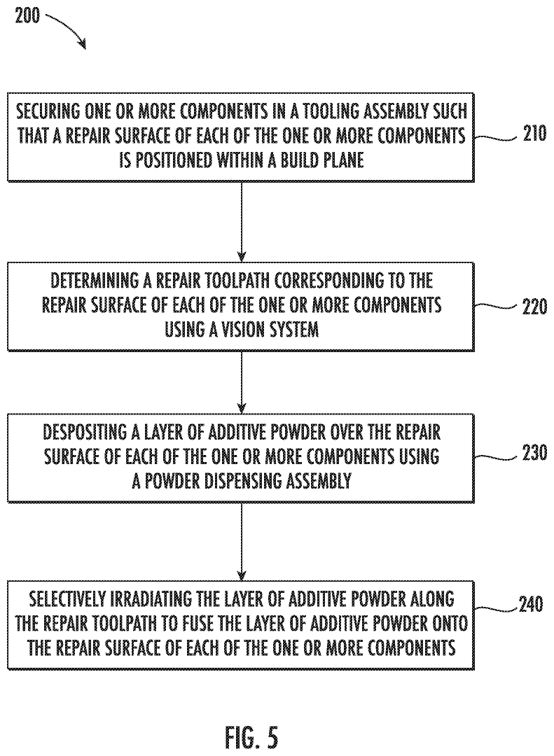

Referring now to FIG. 5, method 200 includes, at step 210, securing one or more components in a tooling assembly such that a repair surface of each of the one or more components is positioned within a build plane. For example, continuing the example from above, a plurality of high pressure compressor blades 70 may be mounted into tooling assembly 52 such that the repair surface 72 of each blade 70 lies in the same horizontal plane, e.g., build plane 82. Method 200 may further include grinding the one or more components to remove material above the repair surface 72, either before or after mounting in tooling assembly 52 or otherwise positioning the blades 70 on build platform 118. For example, material removal assembly 54 or another material removal device may remove worn or defective portions of each blade 70.

Thus, as described in detail herein, aspects of the present subject matter are directed to a system and method for repairing or rebuilding airfoils (e.g., compressor blades) for a gas turbine engine using a powder bed additive manufacturing process, such as a DMLS or DMLM process. The method generally includes a blade preparation step where erosion, defects, and cracks are removed from the airfoils, e.g., by cutting or grinding the airfoils along a cut plane, e.g., less than 0.15 inches from the blade tip. It should be appreciated that according to alternative repair applications, the cut plane may be at a different location of a given component and may remove any suitable depth of such component. However, due to variability in defect depth and in the grinding or material removal process, the height of blades after tip trim can vary significantly from part to part. It is preferable to repair as many blades as possible in one batch to reduce repair time per part and lower costs. A tooling fixture may be used to fix a plurality of blades on a build platform for the additive repair process. More specifically, the tooling fixture may preferably be used to level all blade tips to the same height to facilitate the powder bed additive manufacturing process.

Once the blades are fixed in the tooling fixture, it is desirable to provide the additive manufacturing machine with the print commands or other data necessary to additively rebuild the blade from the repair surface to the desired blade tip. Therefore, method 200 includes, at step 220, determining a repair toolpath corresponding to the repair surface of each of the one or more components using a vision system. For example, the step of determining a repair toolpath may include obtaining a digital representation of the one or more blades 70 using vision system 56 and determining coordinates of the repair surface 72 of each blade 70 from the digital representation of the blades 70. Controller 60 may then determine the repair toolpath 76, which may, for example, include a definition of a plurality of layers to be fused onto repair surface 72 to rebuild each of the one or more components, e.g., a plurality of layers corresponding to the repair segment 74.

Referring now briefly to FIG. 6, an exemplary blade 70 will be described along with an exemplary repair toolpath 72 which may be used to print repair segment 74 onto repair surface of blade 70. According to exemplary embodiments, repair surface 72 may be relatively small, however, additive manufacturing machine 100 may nevertheless additively print repair segment 74 thereon so as to provide a near net shape component (e.g., finished blade 70). For example, as shown in FIG. 6, blade 70 may have repair surface 72 with a cross-sectional width 88 measured perpendicular to a chord line of blade 70 at its thickest location. In addition, blade 70 may have a repair segment 74 with a repair height 90 measured from repair surface 72 to a finished blade tip 92. Furthermore, blade 70 may define a blade height 94 measured from a root of the blade 70 to the finished blade tip 92.

Using the dimensions specified above, blade 70 may fall within a variety of specified dimensional ratios. For example, continuing the example related to the repair of a compressor blade, blade 70 may have a height of approximately 1.5 inches (approx. 38.1 mm) and approximately 0.15 inches (approx. 3.81 mm) may be removed during the material removal step. Thus, the repair height may also be approximately 0.15 inches. According to such an exemplary embodiment, a height-to-repair ratio is approximately 10:1. However, it should be appreciated that the height-to-repair ratio may be any other suitable ratio, e.g., such as about 1:1, about 5:1, about 20:1, about 50:1, or such as at least 100:1.

In some embodiments, blade width 88 may be from about 0.5 millimeters to about 10 centimeters, such as about 0.5 mm to about 5 cm, such as about 0.5 mm to about 1 cm, such as about 0.5 mm to about 10 mm, such as about 0.5 mm to about 5 mm, such as about 0.5 mm to about 3 mm, such as about 1 mm to about 5 mm, such as about 3 mm to about 10 mm, such as about 1 cm to about 10 cm, such as about 10 cm or less, such as about 5 cm or less, such as about 3 cm or less, such as about 1 cm or less, such as about 5 mm or less, such as about 3 mm or less. In other embodiments, a component or blade 70 may have a relatively larger cross-sectional width, such as from about 1 cm to about 25 cm, such as from about 5 cm to about 15 cm, such as from about 5 cm to about 10 cm, such as at least 1 cm, such as at least 5 cm, such as at least 10 cm, such as at least 15 cm, or such as at least 20 cm.

Therefore, in addition, a ratio of blade height 94 to blade width 88, referred to herein as “height-to-width” ratio, may be from about 1:1 to about 100:1, such as from about 1:1 to about 75:1, such as from about 1:1 to about 65:1, such as from about 1:1 to about 35:1, such as from about 2:1 to about 100:1, such as from about 5:1 to about 100:1, such as from about 25:1 to about 100:1, such as from about 50:1 to about 100:1, such as from 75:1 to about 100:1, such as at least 5:1, such as at least 10:1, such as at least 25:1, such as at least 50:1, or such as at least 75:1. In addition, a ratio of repair height 90 to blade width 88, referred to herein as “repair height-to-width” ratio, may be from about 1:1 to about 10:1, such as from about 1:1 to about 7:1, such as from about 1:1 to about 5:1, such as from about 1:1 to about 2:1, such as from about 2:1 to about 10:1, such as from about 5:1 to about 10:1, such as from about 2:1 to about 5:1, such as at least 2:1, such as at least 5:1, or such as at least 7:1.

According to an exemplary embodiment, controller 60 may determine the repair toolpath using an original CAD model of the blades 70. Notably, however, serviced blades frequently do not conform to their nominal CAD models, so the tip CAD model may need to be morphed to fit the blade tip profile. In this regard, an imaging tool or vision system (e.g. camera or 3D scanner) may be used to capture the blade tip and recognize the tip contour (at the trim plane or repair surface) with software. The nominal CAD model of blade tip may then be morphed according to the tip contour to obtain a morphed tip CAD model that conforms to the blades.

The morphed CAD tip model may be imported to the additive manufacturing machine to facilitate the repair process. Specifically, step 230 may include depositing a layer of additive powder over the repair surface of each of the one or more components using a powder dispensing assembly. Step 240 includes selectively irradiating the layer of additive powder along the repair toolpath to fuse the layer of additive powder onto the repair surface of each of the one or more components. In this regard, for example, AM machine 100 may print repair segment 74 directly on repair surface 72 of each of the plurality of blades 70.

For example, the build platform with blades may be installed in the additive manufacturing machine (e.g., a M2 printer from Concept Laser) and additive powder may be loaded and leveled to the same height of blade tip. The printing process may involve fusing the layer of additive powder to the blade tip according to the morphed CAD model, and this process may be repeated until the airfoils are completely repaired or rebuilt. After printing process is complete, the blades with repaired tips are disassembled from the build plate and polished to a target surface finish. In this regard, additive repair system 50 may include a dedicated polishing assembly (not shown) or material removal assembly 54 may be used with an alternate polishing wheel to polish each blade 70.

FIG. 5 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using additive repair system 50 and AM machine 100 as an example, it should be appreciated that these methods may be applied to repairing or rebuilding any other number, type, and configuration of components using any suitable additive manufacturing machine or system.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

COMPONENT LIST

| Reference Character | Component |
|---|---|
| 50 | Additive Repair System |
| 52 | Tooling Assembly |
| 54 | Material Removal Assembly |
| 56 | Vision System |
| 58 | User Interface Panel |
| 60 | Controller |
| 60A | Computing Device(s) |
| 60B | Processor(s) |
| 60C | Memory Device(s) |
| 60D | Instructions |
| 60E | Data |
| 60F | Communication Module |
| 70 | Blade |
| 72 | Repair Surface |
| 74 | Repair Segment |
| 76 | Repair Toolpath |
| 80 | Camera |
| 82 | Build Plane |
| 88 | Blade Width |
| 90 | Repair Height |
| 92 | Finished Blade Tip |
| 94 | Blade Height |
| 100 | AM System |
| 102 | Enclosure or Build Area |
| 104 | Gas Inlet Port |
| 106 | Gas Outlet Port |
| 110 | Table |
| 112 | Powder Supply |
| 114 | Recoater Mechanism |
| 116 | Overflow Reservoir |
| 118 | Build Platform |
| 120 | Energy Source |
| 122 | Energy Beam |
| 124 | Beam Steering Apparatus |
| 130 | Build Surface |
| 132 | Build Opening |
| 134 | Build Chamber |
| 136 | Vertical Walls |
| 140 | Supply Opening |
| 142 | Additive Powder |
| 144 | Reservoir Opening |
| 150 | Supply Container |
| 152 | Supply Platform |
| 154 | Supply Actuator |
| 160 | Recoater Actuator |
| 164 | Platform Actuator |
| 172 | Build Layer |
| 174 | Focal Point |
| 176 | Melt Pool |
| 200 | Method |
| 210-240 | Steps |

What is claimed is:

1. A method (200) for repairing one or more components using an additive repair system, the method (200) comprising:
securing the one or more components in a tooling assembly, each of the one or more components having a repair surface (210);
determining a repair toolpath corresponding to the repair surface of each of the one or more components using a vision system (220);
depositing a layer of additive powder over the repair surface of each of the one or more components using a powder dispensing assembly (230); and
selectively irradiating the layer of additive powder along the repair toolpath to fuse the layer of additive powder onto the repair surface of each of the one or more components (240).

2. The method (200) of claim 1, further comprising:
removing material above the repair surface of each of the one or more components using a material removal assembly.

3. The method (200) of claim 1, wherein the vision system comprises one or more cameras or a three-dimensional scanner.

4. The method (200) of claim 1, wherein the step of determining a repair toolpath corresponding to the repair surface of each of the one or more components (220) comprises:
obtaining a digital representation of the one or more components using the vision system; and
determining coordinates of the repair surface of each of the one or more components from the digital representation of the one or more components.

5. The method (200) of claim 1, further comprising:
polishing the layer of additive powder fused to the repair surface.

6. The method (200) of claim 1, wherein the one or more components comprise at least one airfoil of a gas turbine engine.

7. The method (200) of claim 6, wherein the repair toolpath traverses the repair surface at a tip of the at least one airfoil.

8. The method (200) of claim 6, wherein the at least one airfoil is a high pressure compressor blade.

9. The method (200) of claim 8, wherein a ratio of a blade height of the high pressure compressor blade to a repair height of a repair segment is approximately 10:1.

10. The method (200) of claim 1, wherein the repair toolpath defines a plurality of layers to be fused onto the repair surface to rebuild each of the one or more components.

11. The method (200) of claim 1, wherein fusing the layer of additive powder is achieved using a direct metal laser melting (DMLM) system, an electron beam melting (EBM) system, a selective laser melting (SLM) system, a direct metal laser sintering (DMLS) system, or a selective laser sintering (SLS) system.

12. An additive repair system (50) for repairing one or more components (70), the additive repair system (50) comprising:
a tooling assembly (52) for securing the one or more components (70), each of the one or more components (70) having a repair surface (72);
a vision system (56) for determining a repair toolpath (76) associated with each of the one or more components (70) within the build plane (82);
a powder dispensing assembly (112) for depositing a layer of additive powder (72) over the repair surface (72) of each of the one or more components (70); and
an energy source (120) for selectively irradiating the layer of additive powder (72) along the repair toolpath (76) to fuse the layer of additive powder (72) onto the repair surface (72) of each of the one or more components (70).

13. The additive repair system (50) of claim 12, further comprising:
a material removal assembly (54) for removing material above the repair surface (72) of each of the one or more components (70).

14. The additive repair system (50) of claim 12, wherein the one or more components (70) comprise at least one high pressure compressor blade.

15. The additive repair system (50) of claim 14, wherein a ratio of a blade height of the at least one high pressure compressor blade to a repair height of a repair segment is approximately 10:1.
